(19) United States
(12) Patent Application Publication
(10) Pub. No.: US 2023/0160153 A1
(43) Pub. Date: May 25, 2023

(54) INSTALLING SPRAY MULCH

(71) Applicant: Michael Kessler, Bay City, MI (US)

(72) Inventor: Michael Kessler, Bay City, MI (US)

(21) Appl. No.: 17/456,173

(22) Filed: Nov. 23, 2021

(51) Int. Cl. E01C 19/21; B05D 1/02; E01C 7/30

(52) U.S. Cl. CPC E01C 19/21; B05D 1/02; E01C 7/30

(57) ABSTRACT

A method for providing landscaping materials wherein a predetermined layer of a rubber mulch is placed on a predetermined area of soil and the rubber mulch layer is sprayed with a urethane binder material. Also, there is a method for providing landscaping materials wherein a predetermined area of soil is prepared for treatment and then treated with a weed barrier. Then, a predetermined layer of rubber mulch is applied to the weed barrier treated soil and the rubber mulch layer is sprayed with a urethane binder material. Additional layers of particulate material and binder layer can be applied to the top binder layer in each method.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Applications for poured in place particulate surfacing have abounded in the last few years. Typically, such applications have used particulate rubber with a binder of some kind, and maybe a colorant and a diluent, depending on the end use application, which are pre-mixed prior to application. The binders are the type of binders that cure by exposure to the atmosphere and that typically cure in a short period of time. Usually, the higher the volume of binder in the mix, the longer it takes to fully cure. Historically, if one wanted to use a large amount of binder material for a particular end-use application, one usually added a catalyst to hasten the cure rate of the binder.

Types and brands of binders are many and consist typically of polyurethane chemistry or polyester chemistry. For example, a polyurethane resin is used in U.S. Pat. No. 6,896,964 that issued May 24, 2005, to Kvesic or in U.S. Pat. No. 6,821,623 that issued Nov. 23, 2004, to Kvesic. Also, Polyester resins are used, such as that found in U.S. Pat. No. 6,803,442, that issued Oct. 12, 2004, to Fujimaki, et al.,

Particulate materials usually consist of granulated rubber material such as that found in U.S. Pat. No. 6,036,998 that issued Mar. 14, 2000, to Calvo, et al. or U.S. Pat. No. 10,800,906 that issued to Coe that discloses crumb rubber obtained from recycled tires.

### BRIEF SUMMARY OF THE INVENTION

What is disclosed herein is a method for providing landscaping materials wherein a predetermined layer of a rubber mulch is placed on a predetermined area of soil and the rubber mulch layer is sprayed with a urethane binder material.

“Soil” for purposes of this invention means dirt, sand, stone, and clean gravel, among other surfaces.

A second embodiment is a method for providing landscaping materials wherein predetermined an area of soil is prepared for treatment and then treated with a weed barrier. Then, a predetermined layer of rubber mulch is applied to the weed barrier treated soil and the rubber mulch layer is sprayed with a urethane binder material.

### BRIEF DESCRIPTION OF THE SEVERAL VIEWS OF THE DRAWINGS

FIG. 1 is a side view of an installation of this invention.

FIG. 2 is a side view of an installation of this invention using a weed barrier.

FIG. 3 is a side view of an installation of this invention using more than one layer of particulate material and binder.

### DETAILED DESCRIPTION OF THE INVENTION AND DRAWINGS

It should be noted that all prior art methods of providing landscaping using particulate material and a binder deal with pre-mixing the particulate material and the binder before applying to the surface to be treated with the exception of U.S. Pat. No. 6,319,545, which sprays the particulate material as it is being applied. The binder is applied to the falling particulate materials.

The instant invention deals with adding the particulate materials and then spraying the binder on the particulate materials.

In a typical example, the space to be treated is cleared and readied for such treatment. The particulate material is spread on the cleared area surface at approximate one-half to 1½ inches in thickness, depending on what the space is intended to look like. The binder is added to a sprayer and the particulate material is sprayed with the binder and completely covered. If desired, a layer of particulate material is added to the first layer and the second layer is sprayed with the binder until the particulate material has been completely covered. If desired, a third layer of particulate material can then be added. The bonding agents in this invention consist of binder materials in a diluent along with a colorant if desired and a catalyst if desired.

In another typical example, in a second embodiment, the space to be treated is cleared and readied for such treatment. A weed barrier is laid down over the cleared area. The particulate material is spread on the cleared area weed barrier surface at approximate one inch in thickness, depending on what the space is intended to look like. The binder is added to a sprayer and the particulate material is sprayed with the binder and completely covered. If desired, a layer of particulate material is added to the first layer and the second layer is sprayed with the binder until the particulate material has been completely covered. If desired, a third layer of particulate material can then be added.

Aromatic binders are the most widely used binders for poured in place rubber surfacing. Their specific ingredients are typically a proprietary blend that is known only to the manufacturer. A good aromatic binder will often be custom tailored to meet the installers needs, most importantly the environmental conditions present during installation, i.e., specific heat and humidity levels. Binders are moisture cured, so they will react with direct exposure to water. With some binders this reaction can be devastating with the formation of a foam known as polyurea. Polyurea will destroy the finished look of a poured in place rubber surface and it cannot be repaired without removing the surfacing entirely. Aromatic binders are dark yellow in color and can range from opaque to milky in the liquid form. Upon curing, the binders develop a yellowish tint which will lessen and dissipate over the first few months after installation.

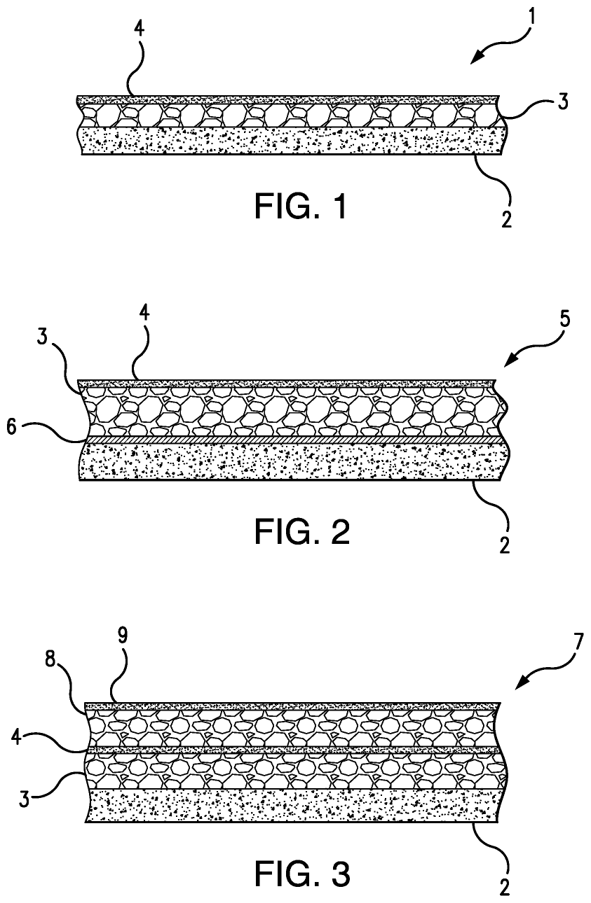

FIG. 1 shows is a side view of an installation of this invention. Shown is the composite 1 formed by the method in which there is shown the cleared space or soil 2, the particulate layer 3, and the binder layer 4.

FIG. 2 is a side view of an installation of this invention using a weed barrier. Shown is the composite 5 formed by the method in which there is shown the cleared space or soil 2, the weed barrier 6, the particulate layer 3, and the binder layer 4.

FIG. 3 is a side view of an installation of this invention using more than one layer of particulate material and binder. Shown is the composite 7 formed by the method in which there is shown the cleared space or soil 2, particulate layer 3, the binder layer 4, a second particulate layer 8 and a second binder layer 9.

What is claimed is:

1. A method for providing landscaping materials, said method consisting essentially of:
A) providing a predetermined layer of a rubber mulch to a prepared
predetermined area of soil, and
B) treating said rubber mulch layer with a sprayed urethane binder material.

2. A method for providing landscaping materials, said method consisting essentially of;
i) preparing a predetermined area of soil for treatment;
ii) treating said soil surface with a weed barrier;
iii) providing a predetermined layer of rubber mulch to said weed barrier treated soil;
iv) treat said rubber mulch layer with a sprayed urethane binder material.

3. A method as claimed in claim 1 wherein a second layer of rubber mulch is added to said predetermined layer of rubber mulch and said second layer of rubber mulch is treated with a spray of binder material.

4. A method as claimed in claim 2 wherein a second layer of rubber mulch is added to said predetermined layer of rubber mulch and said second layer of rubber mulch is treated with a spray of binder material.

5. A method as claimed in claim 1 wherein a third layer of rubber mulch is added to said second layer of rubber mulch.

6. A method as claimed in claim 5 wherein said third layer of rubber mulch is treated with a spray of binder material.

7. A method as claimed in claim 2 wherein a third layer of rubber mulch is added to said second layer of rubber mulch.

8. A method as claimed in claim 7 wherein said third layer of rubber mulch is treated with a spray of binder material.

9. A method as claimed in claim 1 wherein the layer of rubber mulch is from ½ inch to 1½ inches in thickness.

10. A method as claimed in claim 2 wherein the layer of rubber mulch is from inch to 1 inches in thickness.

11. A method as claimed in claim 1 wherein the rubber mulch is colored.

12. A method as claimed in claim 2 wherein the rubber mulch is colored.

13. A method as claimed in claim 1 wherein the rubber mulch has an overall average size of ¼ inch to 1 inch.

14. A method as claimed in claim 2 wherein the rubber mulch has an overall average size of ¼ inch to 1 inch.
